(19) United States
(12) Patent Application Publication
(10) Pub. No.: US 2019/0262967 A1
(43) Pub. Date: Aug. 29, 2019

(54) MULTIPLE POLISHING HEAD

(71) Applicant: T&D Robotics S.R.L., Carrara (MS) (IT)

(72) Inventors: Andrea TOGNONI, Carrara (MS) (IT); Luca TERZAGO, Carrara (MS) (IT)

(21) Appl. No.: 16/281,537

(22) Filed: Feb. 21, 2019

(30) Foreign Application Priority Data
Feb. 28, 2018 (IT) 202018000001995

(51) Int. Cl. B24B 35/00; B25J 11/00

(52) U.S. Cl. CPC B24B 35/00; B25J 11/0065

(57) ABSTRACT

A multiple polishing head (10), especially suitable for working on stone materials to carry out roughing or surface finishing operations on the same and arranged to be combined with a robotic manipulator (20) with multiple degrees of freedom, comprises at least two electrospindles (24), to the front face of which as many tools or machining tools are combined. The polishing head (10) is connected to the wrist (16) of the arm (14) of said manipulator by means of a flange (12), fixed to an inclined plane (18) defining the upper part of a frame (22). The electrospindles (24), preferably three, are connected to the lower face, consisting of a plate (26), of the frame base (22).

The present invention refers to a multiple polishing head.

More particularly, the present invention refers to a multiple polishing head especially suitable for working on stone materials to carry out roughing or surface finishing operations on the same. The polishing head of the present invention is especially suitable and predisposed to be applied to a robotic manipulator with multiple degrees of freedom and includes a support capable of accommodating a multiple number of electrospindles that configure as many different elements bearing tools or equipment able to act alternately on the block of material to be processed. A robotic manipulator, to which the head of the invention is particularly even if not exclusively associable, belongs to the type described in Italian patent no. 1423771 of the same applicant; such manipulator comprises an arm the wrist of which is provided with an attachment for a flange to which operating heads or tools of various types can be connected.

As is known, specific machines and equipment are used for processing stone materials, starting from those with which the sawing of the rough blocks extracted from the quarries is carried out. With the subsequent processing of semi-finished products, typically in the form of sheets or solid slabs, flooring or coating elements, doorsteps, curbs, but also furnishing elements and surfaces such as bathroom and kitchen tops, sinks and built-in basins or countertop sinks are obtained. The articles belonging to the latter category in particular, which can also be made of synthetic marble, plastic resins or even ceramics or glass agglomerates, often require precise finishing operations, which concern, for example, exposed and/or shaped parts such as the edge, sometimes rounded, or parts thereof; these may also involve roughing operations or processing aimed at obtaining a particular surface finish, for example satiny or brushed.

To carry out the necessary operations enabling these and other types of surface finishing to be obtained on the products, special polishing heads are used, which consist of an electrospindle combined with a robotic manipulator; a solution of this kind makes it possible to automate the operating cycle, avoiding repeated and constant intervention by personnel. Nevertheless, it has been found that this solution has some significant drawbacks, related to the fact that the roughing or finishing operations require repeated replacements of the operating head or tool attached to the electrospindle. Although it is possible to replace it with automatic sequences, picking up the replacement tool from a magazine located near the manipulator and carrying out the change by means of the flange provided with special connections, it is nevertheless an operation that requires a certain amount of time and that involves a significant extension of production times, therefore an increase in overall costs, if repeated several times as is often required for the processing needs.

The purpose of the present invention is to overcome the drawbacks complained of above.

More specifically, the purpose of the present invention is to provide a multiple polishing head, i.e. provided with a plurality of electrospindles for as many machining tools, suitable to be used on a robotic manipulator at multiple degrees of freedom, so as to avoid the entire replacement of said tools by enabling the alternative and immediate use on the product of one of those provided on said head.

A further purpose of the invention is to provide a multiple polishing head able to allow the simultaneous use on the product being processed of at least two tools, having the same or different operating characteristics.

A further purpose of the invention is to make available to users a multiple polishing head suitable to ensure a high level of resistance and reliability over time, in addition such as to be easily and economically made.

These and other purposes are achieved by the multiple polishing head of the present invention according to the main claim.

The construction and functional characteristics of the multiple polishing head of the present invention will be more clearly comprehensible from the detailed description below in which reference is made to the appended drawings/diagrams which show a preferred and non-limiting embodiment and wherein:

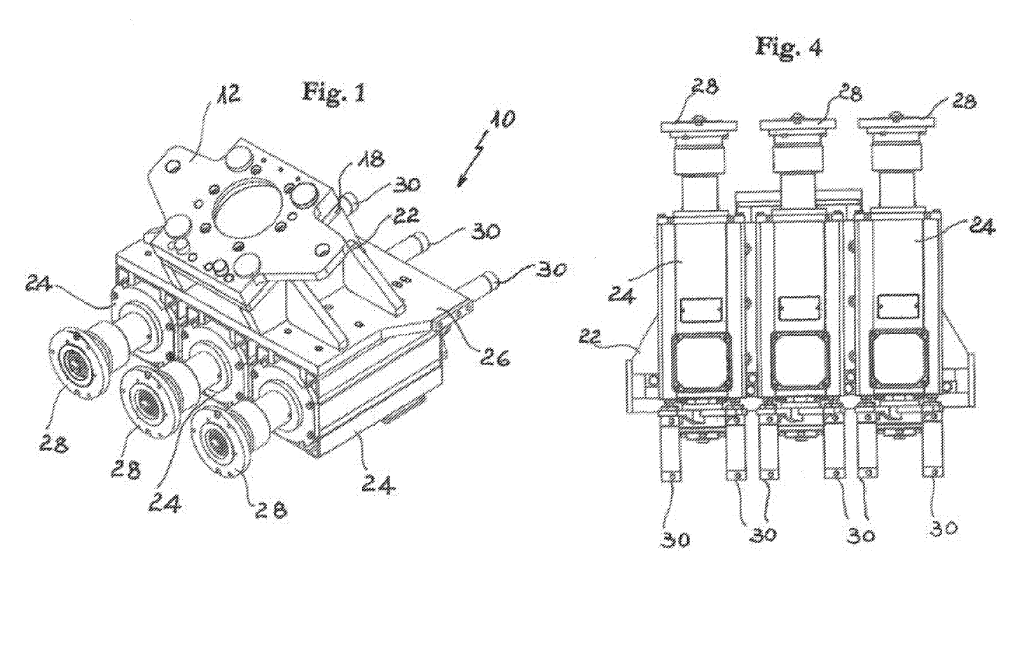

FIG. 1 schematically represents an axonometric top view of the multiple polishing head of the present invention;

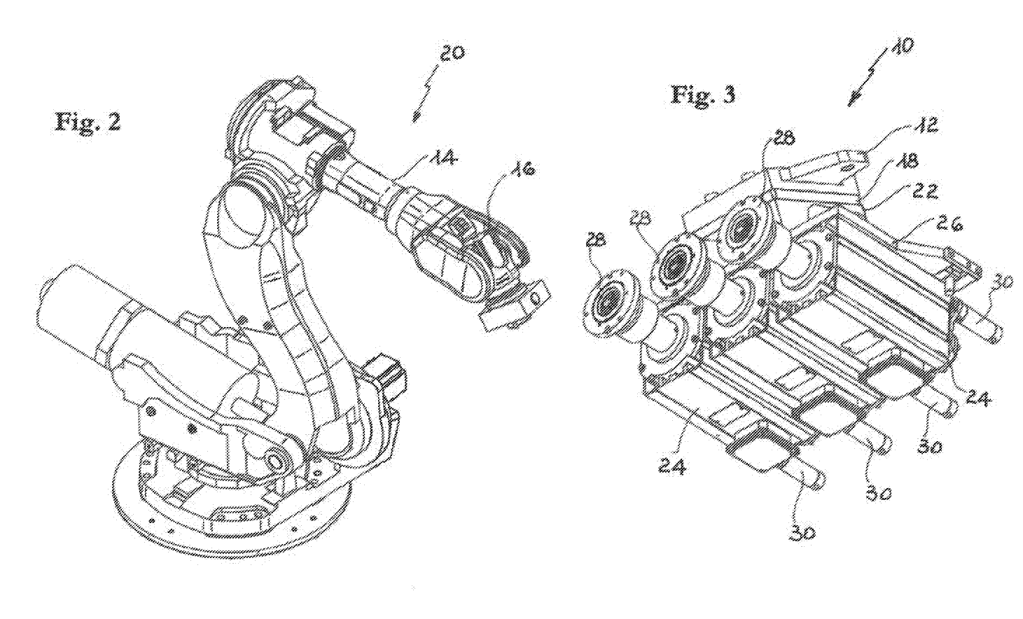

FIG. 2 schematically represents the axonometric view of a robotic manipulator with multiple degrees of freedom to which said polishing head is advantageously paired;

FIG. 3 schematically represents an axonometric view from the bottom of the same polishing head;

FIG. 4 represents a schematic view from the lower face of the same polishing head;

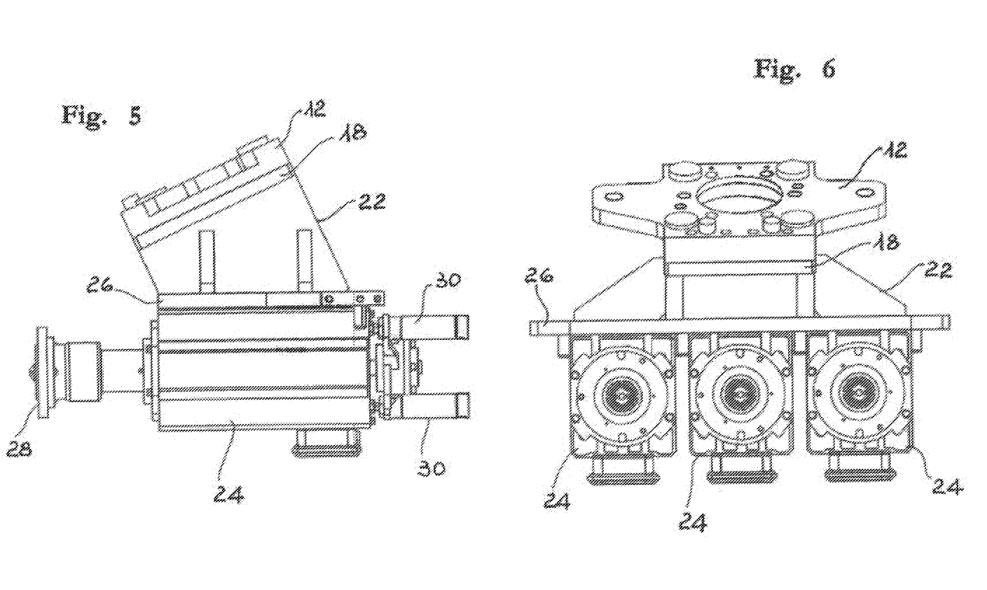

FIG. 5 schematically represents said polishing head in side view;

FIG. 6 schematically represents an axonometric view of the polishing head of the present invention at a different angle from FIG. 1.

With initial reference to FIGS. 1 to 4, the multiple polishing head of the present invention, globally denoted as reference numeral 10 in FIGS. 1 and 3, comprises in the upper part a plate-shaped body that defines the connection flange 12 to the arm 14 of a robotic manipulator, in itself known and globally denoted as reference numeral 20 in FIG. 2; in particular, by means of the flange 12, the polishing head 10 is connected to the so-called wrist, denoted as reference numeral 16, of the arm 14. The flange 12 is fixed by means in themselves known to an inclined plane 18, which defines the upper part of a frame 22; the latter supports at least two electrospindles 24, to which as many tools or machining tools are paired. In particular, the electrospindles 24 are fixed to the lower face of the frame base 22, which defines an extended plate 26. In the preferred embodiment shown in the figures, three electrospindles are provided, aligned and connected to said frame 22 by conventional mechanical devices, or by magnetic attachments. As can be seen from FIGS. 1, 3 and 4, the front face 26 of the electrospindles 24 is suitable to accommodate the machining heads or tools, consisting, for example, of abrasive elements such as grinding wheels and abrasive discs with different grains, suitable to operate sequentially on the item being machined to obtain on it the desired level of surface finish. The opposite rear face of each of the electrospindles 24 comprises respective pneumatic pistons, schematically indicated by reference numeral 30, for adjusting the stroke and exposure of the machining tools fixed to the front face; depending on the type of machining required and the conformation of the product or part of the product to be subjected to finishing, it is therefore possible to activate a single electrospindle 24 with its tool or machining tool, or to activate two or all three electrospindles the tools of which will operate on different and adjacent areas of the item. The possibility of single activation is essential in the case of machining operations that are carried out on non-straight edges; in this case, the pistons 30 expose the tool of a single electrospindle by a pre-defined height, while the others remain rearward and avoid interfering in machining. The possible and adjustable stroke with regard to the exposure of each tool is preferably between 50 and 70 mm.

The electrical and pneumatic power supplies for the electrospindles 24 are made in a known manner, for example starting from connections on the flange 12 or on the arm 14 of the robotic manipulator 20, while the operation of the polishing head 10 as a whole, starting from the individual or multiple activation of the tools connected to said electrospindles, is advantageously managed by software programmed by the off-line method via CAD/CAM. As may be seen from the above, the advantages which the invention achieves are evident. With the multiple polishing head of the present invention it is possible to carry out different machining operations on the products without materially replacing the tools of the electrospindles 24, but moving from one to the other quickly, the same being housed and juxtaposed on the same head; thereby avoiding significant increases in production times and thus processing costs. Particularly advantageous is the possibility of using a single tool with certain characteristics, or simultaneously two or all three tools available to perform different and progressive interventions in sequence; for special machining, as specified above, the tools not used in a given machining phase do not interfere with the one in use, given the advantageous possibility of keeping them in the rearward position or moving them rearwards by means of the pneumatic pistons 30.

Despite the invention having been described above with reference to one of its possible embodiments, given solely by way of a non-limiting example, modifications and variants will appear evident to a person skilled in the art in the light of the above description. The present invention therefore sets out to embrace all the modifications and variants which fall within the scope of protection of the following claims.

1) A multiple polishing head (10), especially suitable for working on stone materials to carry out roughing or surface finishing operations on the same and arranged to be combined with a robotic manipulator (20) with multiple degrees of freedom, characterized in that it comprises at least two electrospindles (24) to the front face of which as many machining tools or tools are paired, the polishing head (10) being connected to the wrist (16) of the arm (14) of said manipulator by means of a flange (12).

2) The polishing head according to claim 1, characterized in that the flange (12) is fixed to an inclined plane (18) defining the upper part of a frame (22).

3) The polishing head according to claim 1, characterized in that it comprises three electrospindles (24), fixed to the lower face of the frame base (22) consisting of a plate (26).

4) The polishing head according to claim 3, characterized in that the electrospindles (24) are aligned with each other on said frame (22) to which they are fixed with mechanical devices or by magnetic attachments.

5) The polishing head according to claim 4, characterized in that the rear face of the electrospindles (24) comprises respective pneumatic pistons (30) for adjusting the stroke and exposure of each of the processing tools fixed to the front face of said electrospindles.

6) The polishing head according to claim 5, characterized in that the possible and adjustable stroke via the pneumatic pistons (30) with regard to the exposure of the tool borne by each of the electrospindles (24) is between 50 and 70 mm.
